(19) United States
(12) Patent Application Publication
(10) Pub. No.: US 2020/0226208 A1
(43) Pub. Date: Jul. 16, 2020

(54) ELECTRONIC PRESENTATION REFERENCE MARKER INSERTION

(71) Applicant: International Business Machines Corporation, Armonk, NY (US)

(72) Inventors: Aparna Subramanian, Plano, TX (US); Shishir Saha, Plano, TX (US)

(21) Appl. No.: 16/249,177

(22) Filed: Jan. 16, 2019

(51) Int. Cl. G06F 17/24; G06K 9/62; G06K 9/00; G10L 15/08

(52) U.S. Cl. CPC G06F 17/241; G06K 9/6267; G10L 2015/088; G06K 9/6202; G10L 15/08; G06K 9/00469

(57) ABSTRACT

According to a computer-implemented method, a visual component and an audio component of an electronic presentation are analyzed. The electronic presentation is classified based on the analysis of the visual component and the analysis of the audio component. A number of transition points for the electronic presentation are identified based on the analysis of the visual component and the analysis of the audio component. Reference markers are inserted into the electronic presentation at certain identified transition points.

### BACKGROUND

The present invention relates to the management and display electronic presentations, and more specifically to the insertion of reference markers into the electronic presentations. In the world today, electronic presentations such as slide presentations are used in many different environments. One such environment is the training of individuals. That is, a corporate, professional, academic, or other presenter may perform user training/education by creating a series of visual displays with text and/or graphics. The presenter may then speak over the presentation of the visual displays. In this example, both the visual display and the audio track may be recorded and made available for subsequent use. For example, the visual and audio training materials may be used for subsequent training./educational purposes.

### SUMMARY

According to an embodiment of the present invention, a computer-implemented method is described. According to the method, a visual component of an electronic presentation is analyzed. An audio component of the electronic presentation is also analyzed. Based on the analysis of the visual component and the analysis of the audio component, the electronic presentation is classified. A number of transition points are then identified, also based on the analysis of the visual component and the analysis of the audio component. Reference markers are then inserted into the electronic presentation at certain identified transition points

The present specification also describes a system. The system includes a visual processor to analyze a visual component of an electronic presentation and an audio processor to analyze an audio component of the electronic presentation. A classifier of the system classifies the electronic presentation based on 1) an output of the visual processor and 2) an output of the audio processor. An identifier of the system identifies a number of transition points for the electronic presentation based on 1) an output of the visual processor indicating a threshold amount of change in pixels between successive frames of the electronic presentation indicating a transition between two slides of the electronic presentation and 2) an output of the audio processor indicating an audio transition. The system also includes a reference marker inserter to insert reference markers into the electronic presentation at certain identified transition points.

The present specification also describes a computer program product. The computer program product includes a computer readable storage medium having program instructions embodied therewith. The program instructions executable by a processor cause the processor to extract text and graphics from a visual component of an electronic presentation. The program instructions are also executable to determine an amount of text and graphics in the electronic presentation, extract keywords and associated metadata from an audio component of the electronic presentation, and classify the electronic presentation as a slide presentation. The classification is done by 1) detecting successive periods of no change in frame pixels and continued audio output, and 2) detecting infrequent and irregular changes to a threshold number of frame pixels. The program instructions are also executable to compare the amount of text and graphics in the electronic presentation and the keywords and associated metadata against a number of templates. The program instructions are further executable to 1) identify a number of visual transition points by detecting changes involving a threshold number of the frame pixels and 2) identify a number of audio transition points by detecting a pause in an audio component of the electronic presentation. The program instructions are also executable to insert reference markers into the electronic presentation based on 1) identified visual transition points, 2) identified audio transition points, and 3) a prioritization policy.

### BRIEF DESCRIPTION OF THE DRAWINGS

FIG. 1 depicts a flowchart of a method for inserting reference markers into an electronic presentation, according to an example of the principles described herein.

FIG. 2 depicts a computing system for inserting reference markers into an electronic presentation, according to an example of principles described herein.

FIG. 3 depicts a flowchart of a method for classifying the electronic presentation, according to another example of principles described herein.

FIG. 4 depicts a flowchart of a method for inserting reference markers into an electronic presentation, according to another example of principles described herein.

FIG. 5 depicts reference marker insertion into an electronic presentation timeline, according to an example of the principles described herein.

FIG. 6 depicts a computer program product with a computer readable storage medium for inserting reference markers into an electronic presentation, according to an example of principles described herein.

### DETAILED DESCRIPTION

The present invention may be a system, a method, and/or a computer program product any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Electronic presentations are one way in which valuable information can be disseminated to a group of individuals. In some cases, at distinct points in time and in varying geographic locations. One specific example is the presentation of training materials. It used to be the case that a trainee would have to be in the same location as the presenter at the time of the presentation. However, with the advent of electronic presentation technology, such limitations no longer exist in the world today. For example, a presenter can make a visual presentation of information such as text, graphics, video, and/or audio. The audio explanation associated with the visual presentation is also recorded. Both the audio and visual components of the presentation are then recorded and saved. Accordingly, a user, anywhere in the world and at any point in time can access the training presentation and consume the valuable information contained therein.

However, such presentations, while undoubtedly advancing the ability to disseminate information to a group of users, still suffer from some inefficiencies. For example, a viewer of the electronic presentation may desire to go to a previous slide. To go back to a particular point in the timeline of the electronic presentation, a user would have to manually scroll back using the video slider. However, such sliders may be inaccurate, especially when a large presentation is represented by the slider. Such manual selection of a particular point in time along the time bar is also time consuming and disruptive to the flow of the electronic presentation.

In some cases, reference markers or annotations, which a user can select, may be inserted into the timeline to direct a user to a predetermined point in the presentation. That is, a user can select a particular reference marker and be directed to a specific point in the presentation. For example, a reference marker may indicate an introduction slide and a second reference marker may indicate a slide that contains the objectives of the presentation with multiple points of emphasis of the presentation. Different reference markers may then be generated for each slide that indicates a newly discussed point of emphasis. These reference markers thereby act as helpful guidelines and indices throughout the electronic presentation.

However, the reference marker insertion is time-consuming and complex as a user generally has to manually place the reference markers. Such a process may also be largely inaccurate as it may be difficult to insert a reference marker at a precise location in the electronic presentation.

Accordingly, the present specification describes methods and systems for inserting reference markers into electronic presentations. Specifically, the present specification describes an approach where an electronic presentation is analyzed and classified as pertaining to a particular type, such as a slide presentation with an audio overlay. Following classification, the electronic presentation is analyzed to identify logical visual transition points between slides. The analysis also identifies logical audio transition points based on pauses in the audio recording. Based on both analyses, reference markers are inserted, or are proposed to be inserted, into the electronic presentation.

The method, system, and computer program product of the present specification provide a number of benefits. For example, the method and system simplify the insertion of reference markers into an electronic presentation, which reference markers enhance the viewing experience of the electronic presentation.

Not only do the current method and system improve the process of insertion of reference markers into the electronic presentation, they also enhance the operation of the computing device on which they are implemented. For example, the proposed method uses parallel processing of both the video and audio components to identify possible reference marker locations. Such parallel processing increases the speed of analysis of the computing device and enhances the accuracy of the results generated.

As another example, the data upon which a presentation classification is made is compared against a library of template presentations. The results of the comparison, i.e., the degree of matching, indicates that the particular presentation is of a particular type. An acceptable variance in the comparison is used 1) to classify the electronic presentation and also 2) to update the library for future comparisons. Accordingly, such an implementation makes the system self-learning, thus improving the operation and overall method over time. Such a method makes the system faster and consume less resources with continued use. As yet another example, the identification of potential transitions and skipping of other transitions reduces the overall number of reference markers that are added to the electronic presentation. The reduction in the number of reference markers reduces the amount of data that is being written/tagged and thus increases the compilation speed and efficiency of the computing system. Thus, as described in at least the following figures, the present method and system improve computer functionality by freeing up bandwidth of the computing system executing the analysis by performing parallel processing of multiple components of an electronic presentation simultaneously. Moreover, memory storage is conserved by reducing the amount of reference markers associated with a given presentation as only reference markers that meet certain criteria are created and inserted into the electronic presentation file.

As used in the present specification and in the appended claims, the term “a number of” or similar language is meant to be understood broadly as any positive number including 1 to infinity.

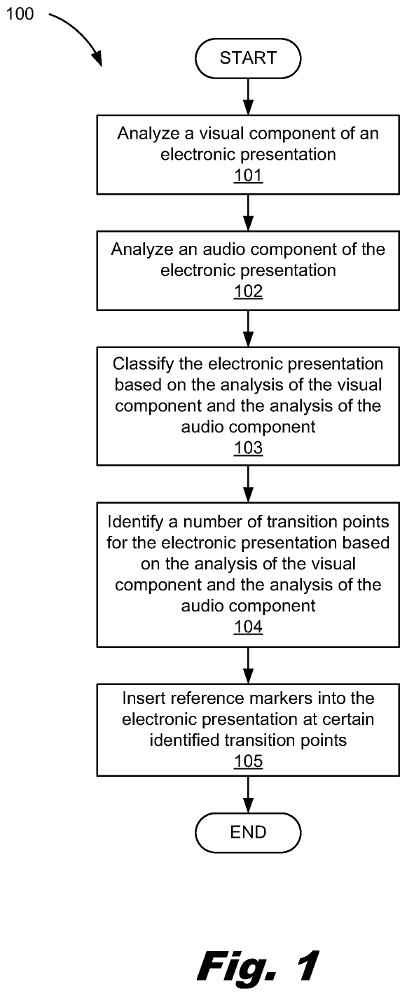

Turning now to the figures, FIG. 1 depicts a flowchart of a method (100) for inserting reference markers into an electronic presentation, according to an example of the principles described herein. As noted above, reference markers greatly aid in the effective navigation through an electronic presentation. However, the insertion of such reference markers may be time-intensive, cumbersome, inaccurate, and imprecise. Accordingly, the present method (100) simplifies, and in some cases automates, such an insertion process.

Specifically, a visual component of the electronic presentation is analyzed (block 101). As described above, the electronic presentation may have a visual component and an audio component. For example, the visual component may be a sequence of slides that present information. Such information may include text, graphics, and/or video. The audio component may be a voice over of the visual presentation. For example, a presenter may speak and explain the content displayed on the slides. In this example, the audio of the presenter represents the audio component of the electronic presentation.

As will be described in more detail below, the visual component may be analyzed (block 101) in any number of ways. As one example, the pixels that make up the visual component may be analyzed. Changes in the different pixels may aid in determining a classification for the electronic presentation and may aid in the identification of video transition points which are candidate locations for insertion of electronic presentation reference markers.

The analysis (block 101) may include extraction of information from the visual component, specifically of text and/or graphics from the electronic presentation. For example, an optical character recognition (OCR) device may convert the text and/or graphics into a form that can be analyzed by a component of the system. In another example, the visual component may be already in a format that may be analyzed by the system. For example, the visual component may be in an editable electronic format, such as a text document, that can be analyzed.

In some examples, the analysis (block 101) of the visual component may be divided into two stages. One for the classification of the electronic presentation and a second for the identification of visual transition points. Dividing the analysis (block 101) into two stages improves computer functionality by reducing processing bandwidth as just that analysis needed for a particular operation (e.g., classification or identification) is performed as needed, thus leading to quicker classification. Doing a single analysis (block 101) for both stages improves computer functionality by reducing potentially overlapping computational operations. That is, rather than extracting text from an electronic presentation two times (once for classification and once for identification), the text may be extracted just once.

The audio component of the electronic presentation is also analyzed (block 102). This analysis (block 102) may be done in parallel to the analysis (block 101) of the visual component of the electronic presentation. Such parallel operation improves computer functionality by increasing processing speeds of the analysis, thus resulting in a quicker analysis that reduces the impact on processing resources, potentially reducing the load on the processing resources and increasing the life of such resources. The audio component of the electronic presentation may be an audio signature that indicates volumes, amplitudes, and frequency of the audio signal generated by a presenter speaking. As will be described below, the audio analysis (block 102) may include a variety of methods including identifying within the audio signature, periods of time where no audio data is detected. Such breaks in the audio signal may indicate an audio transition point, such as when a user pauses to transition to a new slide or to introduce a new topic.

Using both pieces of information, i.e., the visual component analysis and the audio component analysis, the electronic presentation may be classified (block 103). That is, the electronic presentation may be of a particular type and the visual component and audio component analysis may indicate of which type the electronic presentation is. For example, the analysis may determine that the visual component frequently switches between depicting a first actor and a second actor. Moreover, the audio component may indicate that along with the switches in the visual component, the audio component indicates switches in a speaker. Such an analysis may allow for a classification (block 103) of the electronic presentation as an interview between two individuals.

In another example, it may be determined from the visual component analysis (block 101) that there are successive periods of time when there are no changes in the frame pixels while the audio component analysis (block 102) indicates continuous audio output as the frame pixels of the visual presentation are not changing. Moreover, the visual analysis may indicate that while there are successive periods of no change to the frame pixels, there are irregular and infrequent changes to a large number of the frame pixels which may be accompanied by pauses in the audio track. All these characteristics, e.g., 1) successive periods of no change to the pixels of the visual component, 2) irregular and infrequent changes to a threshold number of frame pixels, and 3) continuous audio from a single source overlaying the periods of no-change, may aid in classifying (block 103) the electronic presentation as a slide presentation.

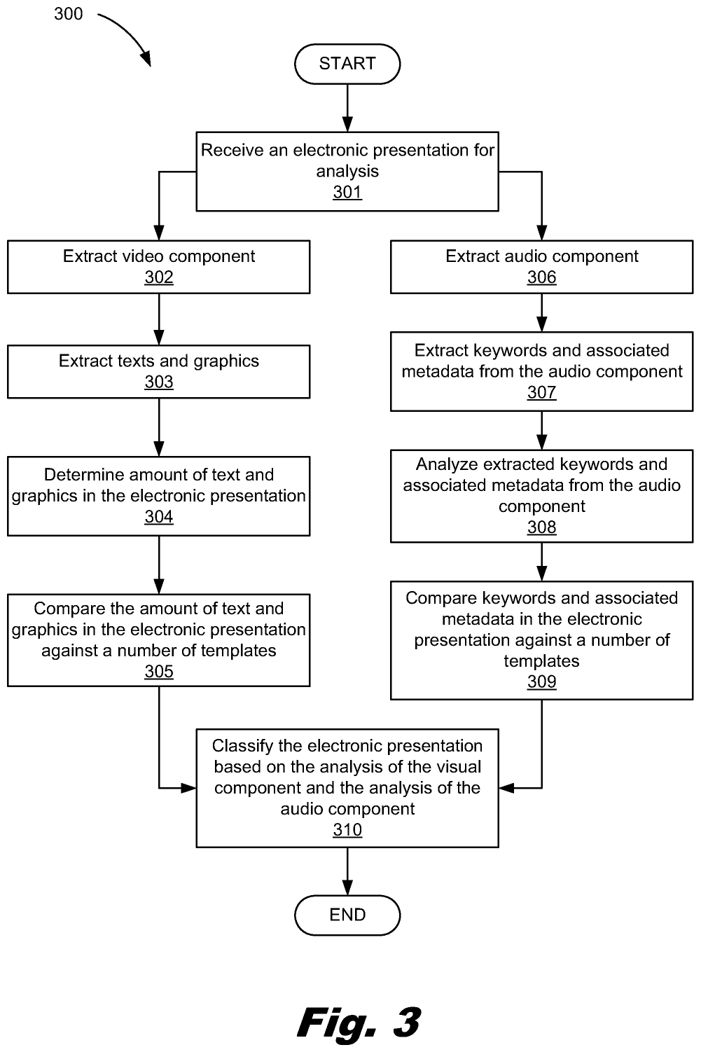

Classifying (block 103) the electronic presentation as pertaining to a particular type aids in the insertion of reference markers into the presentation. For example, certain types of electronic presentations may have certain locations that are more likely to receive reference markers. For example, slide presentations in general may have slides labeled “Outline,” “Conclusion,” and “Q&A.” Such labels may indicate potential reference marker locations. Accordingly, while determining the location of potential reference markers in the electronic presentation, these same words in the electronic presentation may thus indicate potential reference marker locations. More detail regarding the classification (block 103) of the electronic presentation is provided below in connection with FIG. 3.

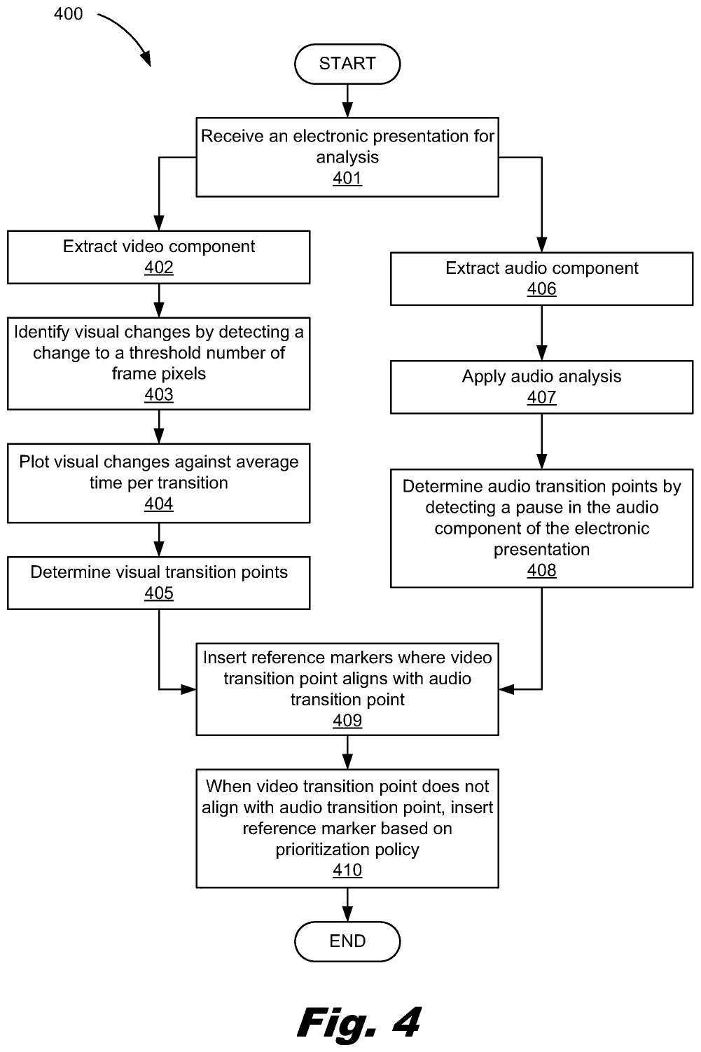

Once classified (block 103), a number of transition points for the electronic presentation are identified (block 104). These transition points form a group of candidate locations for reference markers. The transition points may be a video transition point or an audio transition point. For example, a slide transition is a video transition point and a break in an audio signal is an audio transition point. These points may align with one another, that is they occur at the same time, or may not align, meaning that one occurs at a time stamp independent of the other. Based on certain criteria, reference markers are inserted (block 105) at certain identified transition points. For example, if an audio transition point aligns with a video transition point, a reference marker may be inserted (block 105) at this location. By comparison, if an audio transition point does not align with a video transition point, a prioritization policy may be used to determine whether to insert (block 105) a reference marker at that transition point. More detail regarding the insertion (block 105) of reference markers into the electronic presentation is provided below in connection with FIG. 4.

Accordingly, the present method (100) describes an automated method to analyze visual and audio components of an electronic presentation. The output of these analyses is used to determine where, and whether, to place reference markers. A user in this example, would not have to manually insert the reference markers. Thus, this method (100) is simple, effective, and time-efficient. Moreover, as has been described such a method (100) improves computer functionality by reducing storage size of the electronic presentation files, enhancing processing times for the electronic presentations, and reducing processor loading during playback, analysis, and storage.

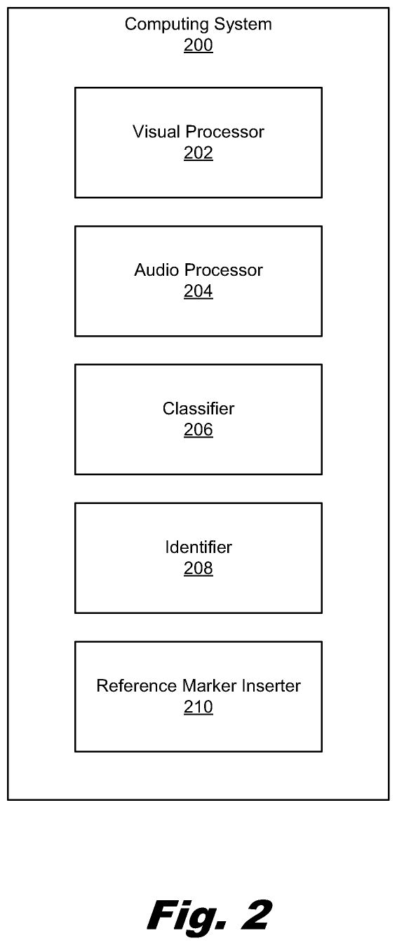

FIG. 2 depicts a computing system (200) for inserting reference markers into an electronic presentation, according to an example of principles described herein. To achieve its desired functionality, the computing system (200) includes various components. Each component may include a combination of hardware and program instructions to perform a designated function. The components may be hardware. For example, the components may be implemented in the form of electronic circuitry (e.g., hardware). Each of the components may include a processor to execute the designated function of the component. Each of the components may include its own processor, but one processor may be used by all the components. For example, each of the components may include a processor and memory. Alternatively, one processor may execute the designated function of each of the components.

In general, the computing system (200) may be disposed on any variety of computing devices. For example, the computing device may be a desktop computer, a laptop computer, a server, a mobile phone, or any other such device that includes processors and hardware components. In some examples, the computing system (200) may be disposed on a user device. In this example, the computing system (200) components operate upon download of the electronic presentation. For example, a user may access a database or storage location where the electronic presentation is stored. Upon download, the visual processor (202) and audio processor (204) may operate to analyze the video and audio components, the classifier (206) may operate to classify the electronic presentation, the identifier (208) may identify the transition points and the reference marker inserter (210) may insert a reference marker or other position indicia into the electronic presentation.

In another example, the computing system (200) may be disposed on a computing device remote from the user device, such as a server. In this example, the computing system (200) components operate upon upload of the electronic presentation. For example, a presenter or other administrator may save the electronic presentation to a database or other storage location. Upon upload, the visual processor (202) and audio processor (204) may operate to analyze the video and audio components, the classifier (206) may operate to classify the electronic presentation, the identifier (208) may identify the transition points and the reference marker inserter (210) may insert a reference marker or other position indicia into the electronic presentation.

The computing system (200) includes a variety of components. For example, the visual processor (202) analyzes a visual component of an electronic presentation. Such analysis may include a pixel-by-pixel analysis of the visual component of the electronic presentation to detect changes therein. The visual processor (202) may also extract certain information, such as text and/or graphics from the visual component. Such an extraction may be via an optical character recognition system or analysis of an editable format of text.

The audio processor (204) analyzes an audio component of the electronic presentation. Specifically, the audio processor (204) may analyze the audio signal output from the presentation to determine breaks in the audio signal.

As described above, the audio processor (204) and the visual processor (202) may be used for two different operations of the computing system (200). First, the output of the visual processor (202) and the audio processor (204) may each perform a first analysis which is output to the classifier (206) and used to classify the electronic presentation. Each of these components may perthrm a second analysis which is output to the identifier (208) to identify respective transition points for potential placement of reference markers or other markers in the electronic presentation. In some examples the first and second analysis for each of the video processor (202) and the audio processor (204) may be performed simultaneously.

The computing system (200) also includes a classifier (206) that classifies the electronic presentation based on an output of the visual processor (202) and an output of the audio processor (204). That is, the electronic presentation may be any type of presentation including a slide presentation, a townhall meeting, an interview, a classroom lecture, etc. The visual and audio outputs of the respective processors may indicate the type of electronic presentation. For example, a visual processor (202) output that indicates sequential periods of no change to the pixels separated by infrequent and irregular changes to large amounts of pixels and an audio processor (204) output that indicates audio overlay of the whole visual presentation by a single speaker may indicate that the electronic presentation is a slide presentation.

Classification of the electronic presentation facilitates a more streamline insertion of reference markers. That is, different types of electronic presentations may have different characteristics that lend to insertion of reference markers at particular points in time. Accordingly, the classification sets up a baseline to which the electronic presentation may be compared.

An identifier (208) of the computing system (200) identities transition points. As with the classification, the identification of transition points may be based on the output of the visual processor (202) as well as the output of the audio processor (204). For example, the output of the visual processor (202) may indicate that a threshold number of frame pixels change between successive frames of the electronic presentation. Such a transition indicates a transition between two slides of the electronic presentation and therefore a candidate location for a reference marker. As another example, the output of the audio processor (204) may indicate a break in the audio signature indicate a speaking pause, for example a change between topics, again providing a candidate location for a reference marker.

A reference marker inserter (210) of the computing system (200) can then place reference markers into the electronic presentation at certain identified transition points. For example, a reference marker may be placed at a location along the timeline of the electronic presentation where both a video transition point and an audio transition point are located. Reference markers may also be placed at locations along the timeline where video and audio transition points do not align. Such placement may be selected on a prioritization policy that indicates how to determine where different reference markers are to be placed.

In some examples, the reference marker inserter (210) places the reference markers automatically. That is, without further user input. In other examples, a prompt is displayed on a user interface. In this example, user verification is to be received before placement of the reference markers.

FIG. 3 depicts a flowchart of a method (300) for classifying the electronic presentation, according to another example of principles described herein. Specifically, as described above, the method depicted in FIG. 1 can be broken up into two stages. The first stage includes a classification of the electronic presentation and the second stage relates to the actual insertion of the reference markers. FIG. 3 depicts a flowchart of the first stage. Specifically, FIG. 3 depicts electronic presentation analysis to identify a type of electronic presentation. In this example, an electronic presentation is received (block 301) for analysis. As described, such reception may be upon upload to a server or upon download to a user device. As used in the present specification, the term electronic presentation refers to any presentation of visual and/or audio components in electronic format and may include any variety of types. For example, the electronic presentation may be a video recording, a recording of a townhall meeting, a video interview, or a slide presentation.

Once received, the video component and the audio component are extracted (block 302, 306) and separated for individual analysis. Specifically, in regards to the video component, text and graphics are extracted (block 303) from the video component. For example, an object character recognition device may be used to identify the visual components. In another example, the text and graphics may be in an already editable text format. In either case, information relating to the text and/or graphics may be extracted (block 303) from the video component and analyzed. From this analysis, the amount of text and graphics presented in the electronic presentation is determined (block 304). That is, the quantity of text and graphics in the video component may be analyzed. Alternatively, or additionally, the percentage of text and graphics, as compared against other components such as background information, is determined. Such information may be indicative of a type, or classification of electronic presentation. For example, the presence of a majority of text and other visual aids such as bar graphs, pie charts, etc., is indicative that the electronic presentation is a slide presentation as opposed to say for example a recorded interview.

The information relating to the amount and quantity of text/graphics in a visual display may be compared (block 305) against a number of templates. That is, the computing system (FIG. 2, 200) may look for identifiable patterns in the electronic presentation (based on the amount/prevalence of text and/or graphics) and map it to a template. For example, as described above, slide presentations include more on-screen text than for example, a video recording of an interview. Thus, a comparison (block 305) is made of a visual component of an electronic presentation that has a relatively high percentage of text per frame against a library of templates. The relatively high percentage of text may map more closely to a slide presentation than a recorded interview template and thus lends to classifying this electronic presentation as a slide presentation.

In addition to analyzing the video component, the computing system (FIG. 2, 200) also analyzes the audio component. Specifically, keywords and associated metadata may be extracted (block 307) from the audio component. Certain keywords may be indicative of one type of electronic presentation over another. For example, words such as “presentation,” “training,” “employee,” and “how-to,” may be indicative of a slide presentation, for example as used for training. Accordingly, the extracted (block 307) keywords and metadata may be analyzed (block 308) by an audio processor (FIG. 2, 204) that is capable of identifying and distinguishing words from an audio signal. As with the video analysis, this information relating to the keyword and metadata analysis may be compared (block 309) against a number of templates. That is, the computer system (FIG. 2, 200) would look for identifiable patterns in the presence and frequency of certain keywords. This information may be mapped to a library of templates. For example, as described above, slide presentations may include certain frequently used keywords, for example “presentation,” “conclusion,” “questions and answers.” Thus, a comparison (block 309) is made of the presence and frequency of certain keywords and metadata found in an analysis of the audio component of an electronic presentation to a library of templates. If there is a threshold degree of similarity, this lends to classifying this electronic presentation as a slide presentation.

By performing both comparisons (block 305, 309), the computing system (FIG. 2, 200) may classify (block 310) the electronic presentation. For example, as has been described above, video analysis that indicates a large amount of text/graphics and infrequent changes to the frame pixels and audio analysis that indicates constant audio output from a single source may indicate that electronic presentation is a slide presentation as opposed to a recorded interview, townhall meeting, etc. where such characteristics are distinct from those analyzed. In other words, the slide presentation may be defined as having a series of still images with overlaying audio. However, in some examples, the still images may have embedded video presentations.

FIG. 4 depicts a flowchart of a method (400) for inserting reference markers into an electronic presentation, according to another example of principles described herein. That is, FIG. 4 depicts the second stage of reference marker-insertion, that is the insertion of a reference marker following the classification of the electronic presentation. In this example, an electronic presentation is received (block 401) for analysis and the video and audio components are extracted (block 402, 406). In some examples, these operations may be combined with similar operations described in FIG. 3. That is, rather than extracting the video and audio components two times, one extraction per processor may be performed. In this example, the extracted data may be used both for classification as described in connection with FIG. 3 and for the identification of transition points and reference marker insertion as described in connection with FIG. 4.

As with the assification, the video radio components may be analyzed separately. Specifically, in regards to the video component, visual changes may be identified (block 403) by detecting changes to a threshold number of frame pixels. That is, as described above slide presentations are characterized by infrequent changes to the pixels that make up the visual component. Accordingly, a sufficiently large transition may be indicative of a candidate reference marker. Accordingly, the computing system (FIG. 2, 200) identifies (block 403) such changes. This may be done on a pixel-by-pixel basis. That is, the visual component may have a display size that includes a variety of pixels. If a threshold number of pixels changes, it may indicate that the presentation has been advanced from one slide to the next.

In some examples, the computing system (FIG. 2, 200) may plot (block 404) the visual changes against average times per transition. That is, the library of slide presentation templates may indicate that for an electronic presentation of a particular length, a user may, on average, display a particular slide for a particular amount of time. This period, while not dispositive, may be a candidate location for a reference marker. Accordingly, the identified (block 403) visual changes may be plotted (block 404) against this average time. Those times that match up may be identified as locations where a reference marker may be placed. In another example, the computing system (FIG. 2, 200) calculates the average time of static pixels on the screen and with a knowledge of this average time may determine (block 405) a candidate visual transition point.

In some examples, the average time per transition may be based on a slide heading. For example, some common slide types such as a summary slide, an index slide, an agenda slide, a sub topic slide, a breakout slide, and a Q&A slide may have average duration times associated with each. When such slides are present in the electronic presentation, they may be used to determine: the average slide time against which the identified (block 403) visual changes are plotted (block 404).

Based on the identification (block 403) of visual changes and plotting (block 404) of the identified changes against an average time per transition, the computing system (FIG. 2, 200) and more specifically the identifier (FIG. 2, 210) determines (block 405) visual transition points that may be locations to which a reference marker is inserted.

Turning to the audio component, the audio component may be analyzed (block 407) to determine audio breaks in the signal. That is, the audio processor (FIG. 2, 204) may identify breaks in the audio signal which may be indicative of a break in the presentation. Breaks in the presentation may indicate audio transition points. Accordingly, the audio processor (FIG. 2, 204) determines (block 408) audio transition points by detecting a pause in the audio component of the electronic presentation.

With the video transition points determined (block 405) and the audio transition points detected (block 408), reference markers may be inserted. Specifically, reference markers may be inserted (block 409) at locations where the video transition point aligns with the audio transition points. Such a location indicates that 1) there is a change to slides and 2) that the speaker pauses. Such is a likely place for a reference marker. As described above, as an additional measure of accuracy, in some examples insertion of any reference marker, including one at an aligned location, is first verified by a user via a user interface of the computing system (FIG. 2, 200). That is, the computing system (FIG. 2, 200) pay present a prompt to the user requesting authorization to place a noted reference marker.

Reference markers may also be inserted when video transition points and audio transition points do not align. In such cases, insertion (block 410) is based on a prioritization policy. That is, reference markers may be inserted (block 410) into the electronic presentation based on a prioritization policy when an audio transition point does not align with a visual transition point. In one example, the prioritization policy may indicate 1) the insertion of a reference marker at a location of an audio transition point that does not align with a visual transition point and 2) the prohibition of an insertion of a reference marker at a location of a visual transition point that does not align with an audio transition point. That is, a reference marker is inserted (block 410) when an appropriate pause is identified, so as to put a reference marker at the end of a sentence even when the video transition has happened. This is to cover instances when an out of sequence transition happens where the presenter is still talking about the topics in previous slides while the video has moved to the next slide.

Note that the methods described herein are independent of a direction of the slide presentation. That is, the method (400) also accounts for a presenter going backwards within the slides. That is the present method places a reference marker at any detected transition regardless of whether a slide advances or retraces.

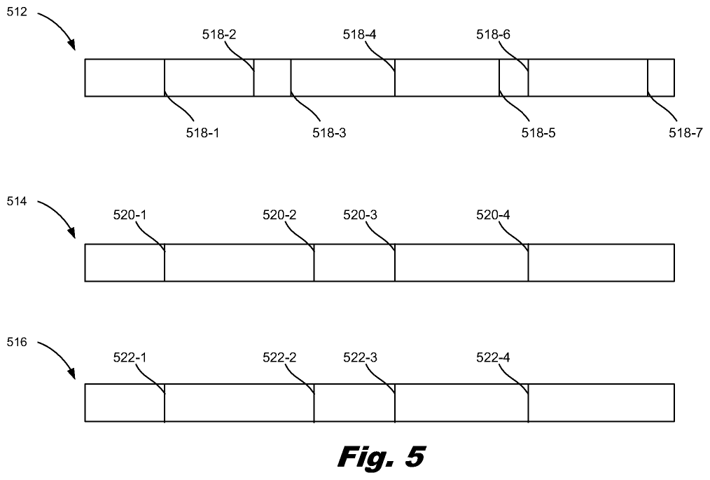

FIG. 5 depicts reference marker (522) insertion into an electronic presentation (516), according to an example of the principles described herein. Specifically, FIG. 5 depicts the visual component (512) timeline, the audio component (514) timeline, and an electronic presentation (516) timeline, each represented as simplified boxes. FIG. 5 also depicts visual transition points (518-1, 518-2, 518-3, 518-4, 518-5, 518-6, 518-7) and audio transition points (520-1, 520-2, 520-3, 520-4, 520-5) as determined by the video processor (FIG. 2, 202) and the audio processor (FIG. 2, 204) respectively.

As described above, reference markers (522) may be placed at locations on the electronic presentation (516) timeline when a visual transition point (518) aligns with an audio transition point (520). For example, a first reference marker (522-1), third reference marker (522-3), and fourth reference marker (522-4) may be placed on the electronic presentation (516) timeline where a corresponding visual transition point (518) and audio transition point (520) align. By comparison, a second reference marker (522-2) may be inserted regardless of the fact that video and audio transition points (518, 520) do not align. In this example, the reference marker (522) may be placed to align with the audio transition point (520-2) to, as described above, to cover instances when an out of sequence transition happens where the presenter is still talking about the topics in previous slides while the video has moved to the next slide.

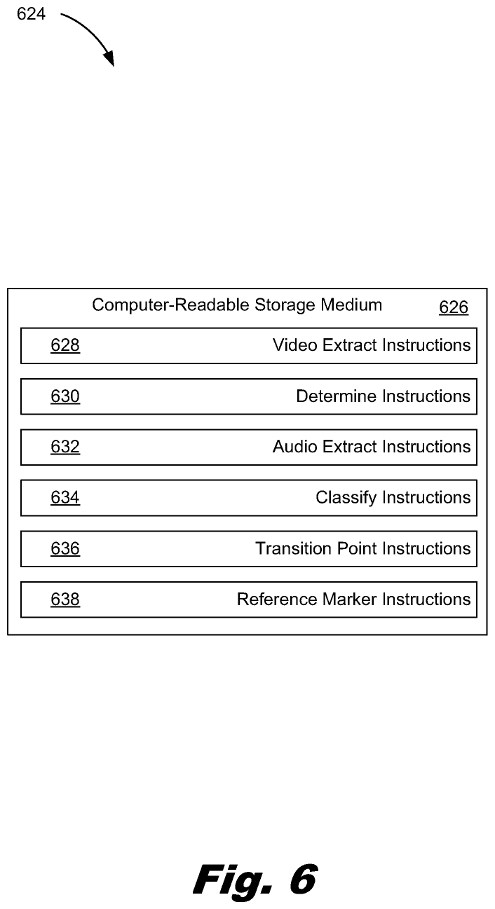

FIG. 6 depicts a computer program product (524) with a computer readable storage medium (626) for inserting reference markers (FIG. 5, 522) into an electronic presentation (FIG. 5, 516), according to an example of principles described herein. To achieve its desired functionality, a computing system includes various hardware components. Specifically, a computing system includes a processor and a computer-readable storage medium (626). The computer-readable storage medium (6266) is communicatively coupled to the processor. The computer-readable storage medium (626) includes a number of instructions (628, 630, 632, 634, 636, 638) for performing a designated function. The computer-readable storage medium (626) causes the processor to execute the designated function of the instructions (628, 630, 632, 634, 636, 638).

Referring to FIG. 6, video extract instructions (628), when executed by the processor, cause the processor to extract text and graphics from a visual component (FIG. 5,5 12) of an electronic presentation (FIG. 5, 516). Determine instructions (630), when executed by the processor, may cause the processor to, determine an amount of text and graphics in the electronic presentation (FIG. 5, 516). Audio extract instructions (632), when executed by the processor, may cause the processor to extract keywords and associated metadata from the electronic presentation (FIG. 5, 516). Classify instructions (634), when executed by the processor, may cause the processor to classify the electronic presentation (FIG. 5, 516) as a slide presentation by 1) detecting successive periods of no change in frame pixels and continued audio output, 2) detecting infrequent and irregular changes to a threshold number of frame pixels; and 3) compare the amount of text and graphics in the electronic presentation (FIG. 5, 516) and the keywords and associated metadata against a number of templates. Transition point instructions (636), when executed by the processor, may cause the processor to identify a number of visual transition points (FIG. 5, 518) by detecting changes involving a threshold number of the frame pixels and to identify a number of audio transition points (FIG. 5, 520) by detecting a pause in an audio component (FIG. 5, 514) of the electronic presentation (FIG. 5, 516). Reference marker instructions (638), when executed by the processor, may cause the processor to insert reference markers (FIG. 5, 522) into the electronic presentation (FIG. 5,5 16) timeline based on 1) identified visual transition points (FIG. 5, 518), 2) identified audio transition points (FIGS. 5, 520), and 3) a prioritization policy.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor of the computing system or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
extracting text and graphics from a visual component of an electronic presentation;
determining an amount of text and graphics in the electronic presentation;
extracting keywords and associated metadata from an audio component of the electronic presentation;
classifying the electronic presentation as a slide presentation by:
detecting successive periods of no change in frame pixels and continued audio output
detecting infrequent and irregular changes to a threshold number of frame pixels; and
comparing the amount of text and graphics in the electronic presentation and the keywords and associated metadata against a number of templates;
identifying a number of visual transition points by detecting changes involving a threshold number of the frame pixels;
identifying a number of audio transition points by detecting a pause in an audio component of the electronic presentation; and
inserting reference markers into the electronic presentation based on:
identified visual transition points;
identified audio transition points; and
a prioritization policy.

2-8. (canceled)

9. The computer-implemented method of claim 1, wherein inserting reference markers into the electronic presentation comprises inserting a reference marker where an audio transition point aligns with a visual transition point.

10. The computer-implemented method of claim 1, wherein inserting reference markers into the electronic presentation comprises inserting a reference marker based on the prioritization policy when an audio transition point does not align with a visual transition point.

11. The computer-implemented method of claim 10, wherein the prioritization policy indicates:
insertion of a reference marker at a location of an audio transition point that does not align with a visual transition point; and
prohibition of insertion of a reference marker at a location of a visual transition point that does not align with an audio transition point.

12. The computer-implemented method of claim 1, wherein inserting reference markers into the electronic presentation comprises inserting a reference marker into the electronic presentation based on at least one of a slide type and an average amount of time for a slide.

13. A system, comprising:
a visual processor to analyze a visual component of an electronic presentation;
an audio processor to analyze an audio component of the electronic presentation;
a classifier to classify the electronic presentation based on:
an output of the visual processor; and
an output of the audio processor;
an identifier to identify a number of transition points for the electronic presentation based on:
an output of the visual processor indicating a threshold amount of change in pixels between successive frames of the electronic presentation indicating a transition between two slides of the electronic presentation; and
an output of the audio processor indicating an audio transition; and
a reference marker inserter to insert reference markers into the electronic presentation at certain identified transition points, wherein
the system is to:
extract text and graphics from a visual component of an electronic presentation;
determine an amount of text and graphics in the electronic presentation;
extract keywords and associated metadata from an audio component of the electronic presentation;
classify the electronic presentation as a slide presentation by:
detecting successive periods of no change in frame pixels and continued audio output
detecting infrequent and irregular changes to a threshold number of frame pixels; and
comparing the amount of text and graphics in the electronic presentation and the keywords and associated metadata against a number of templates;
identify a number of visual transition points by detecting changes involving a threshold number of the frame pixels;
identify a number of audio transition points by detecting a pause in an audio component of the electronic presentation; and
insert reference markers into the electronic presentation based on:
identified visual transition points;
identified audio transition points; and
a prioritization policy.

14. The system of claim 13, wherein the system further comprises a user interface to prompt a user for input confirming insertion of a proposed reference marker before the proposed reference marker is inserted.

15. The system of claim 13, wherein the visual processor and the audio processor each perform:
a first analysis which is output to the classifier; and
a second analysis which is output to the identifier.

16. The system of claim 13, wherein the system is:
disposed on a user device and the system components operate upon download of the electronic presentation; or
disposed on a server remote from the user device and the system components operate upon upload of the electronic presentation.

17. A computer program product, the computer program product comprising a computer readable storage medium having program instructions embodied therewith, the program instructions executable by a processor to cause the processor to:
extract text and graphics from a visual component of an electronic presentation;
determine an amount of text and graphics in the electronic presentation;
extract keywords and associated metadata from an audio component of the electronic presentation;
classify the electronic presentation as a slide presentation by:
detecting successive periods of no change in frame pixels and continued audio output;
detecting infrequent and irregular changes to a threshold number of frame pixels; and
comparing the amount of text and graphics in the electronic presentation and the keywords and associated metadata against a number of templates;
identify a number of visual transition points by detecting changes involving a threshold number of the frame pixels;
identify a number of audio transition points by detecting a pause in an audio component of the electronic presentation; and
insert reference markers into the electronic presentation based on:
identified visual transition points;
identified audio transition points; and
a prioritization policy.

18. The computer program product of claim 17, wherein reference markers are inserted automatically.

19. The computer program product of claim 17, wherein a slide presentation is classified as a series of still images with overlaying audio.

20. The computer program product of claim 19, wherein a still image comprises an embedded video presentation.

21. The method of claim 1, wherein reference markers are inserted automatically.

22. The method of claim 1, wherein a slide presentation is classified as a series of still images with overlaying audio.

23. The method of claim 1, wherein a still image comprises an embedded video presentation.
